(19) United States
(12) Patent Application Publication
(10) Pub. No.: US 2013/0049512 A1
(43) Pub. Date: Feb. 28, 2013

(54) AXIAL FLUX PERMANENT MAGNET SYNCHRONOUS GENERATOR AND MOTOR

(71) Applicant: Taeuk Jung, Changwon-si (KR)

(72) Inventor: Taeuk Jung, Changwon-si (KR)

(73) Assignee: UNDUSTRY-ACADEMIC COOPERATION FOUNDATION OF KYUNGNAM UNIVERSITY, Changwon-si, Gyeongsangnam-do (KR)

(21) Appl. No.: 13/522,206

(22) PCT Filed: Jun. 18, 2012
(86) PCT No.: PCT/KR12/04800

§ 371 Date: Jul. 13, 2012

(30) Foreign Application Priority Data
Aug. 26, 2011 (KR) 10-2011-0085567

(51) Int. Cl. H02K 21/24

(52) U.S. Cl. 310/156.36

(57) ABSTRACT

An axial flux synchronous generator for wind turbine generators is provided including a shaft coupled to receive power with a power generating apparatus for the wind turbine; a rotor coupled rotatably to the shaft and having upper and lower disk-like faces affixed with a plurality of skewed permanent magnets having north-south (N-S) pole pairs and distantly arranged; an upper stator and a lower stator both having a plurality of slots formed similar to the skewed permanent magnets for taking windings of a coil, the upper stator being displaced relative to the lower stator by an electric angle in the range of 25˜30°; an upper housing and a lower housing for housing the rotor, the upper stator and the lower stator together; and a hub housing for fastening the upper housing and the lower housing to maintain constant gaps between the rotor and the upper stator and the lower stator.

### TECHNICAL FIELD

The present disclosure relates to an axial flux permanent magnet synchronous generator and motor. More particularly, the present disclosure relates to a synchronous generator and motor constructed for effectively reducing cogging torque.

### BACKGROUND

The statements in this section merely provide background information related to the present disclosure and may not constitute prior art.

Recent technological interests point to a gearless type axial flux permanent magnet synchronous generator to achieve an improved efficiency and power increase of the wind turbine generator.

Moreover, the axial flux permanent magnet synchronous generator may be made into a thin disc shape with magnetic flux for generating the torque extending in the same direction as the axis of the generator. The synchronous generator can operate with high-efficiency relative to other generators since it has shorter magnetic path.

FIG. 1 illustrates a prior art AFPM (axial flux permanent magnet) coreless multi-generator or motor. In such conventional generator or motor, a stator has an array of coils installed between upper and lower jig plates made of a non-magnetic material, filling the space where the coils are installed with cooling insulation oil and sealing the space by a side jig plate; and another side jig plate fixedly mounted for allowing heat transfer in an housing of the generator. A rotor has a rotor disc made of a magnetic material and installed with annular arrays of magnets and formed with an integral yoke section erected to a predetermined height and located centrally and internally of the array of magnets. The rotor disc is fixedly mounted to the axis of rotation, and the integral yoke section engages an opposing integral yoke section of an adjacent rotor and acts as a conduit of the magnetic field in the coreless generator. The rotor and stator are constructed in a multiple paired arrangement, and the same configuration of generator is suggested as being applicable to a motor.

Although such coreless stator configuration has the merit of avoiding the cogging torque, greater magnetoresistance in airgaps generates lower voltage, and thereby degrades the output efficiency.

### DISCLOSURE

### Technical Problem

The present embodiments provide an axial flux permanent magnet synchronous generator or motor. The generator may be used for wind turbine generators for reducing the cogging torque generated in the permanent magnet synchronous generators, and thereby achieving improved efficiency of power generation and higher output voltage over conventional coreless stator-axial flux permanent magnet synchronous generators.

### Summary

An embodiment of the present disclosure provides an axial flux permanent magnet synchronous generator for a wind turbine generator. Another embodiment may provide an axial flux permanent magnet synchronous motor. The synchronous generator or motor includes: a shaft; a rotor coupled to the shaft and having upper and lower disk-like faces affixed with a plurality of skewed permanent magnets having north-south (N-S) poles and distantly arranged; an upper stator and a lower stator both having a plurality of slots formed similar in shape to the skewed permanent magnets for taking windings of a coil, the upper stator being displaced relative to the lower stator by a predetermined electric angle of displacement; an upper housing and a lower housing for housing the rotor, the upper stator and the lower stator together; and a hub housing for fastening the upper housing and the lower housing to maintain constant gaps between the rotor and the upper stator and the lower stator.

The stator displacement angle of the upper stator and the lower stator may be expressed by electrical angle as

$${α}_{sde} = {90}^{°} \times \frac{H C F \{ {N}_{s} , P \}}{{N}_{s}}$$

and determined in the range of

$$\pm \frac{{360}^{°}}{{N}_{s}} .$$

Here, Nₛ is the number of the slots, P is the number of the permanent magnets and HCF{Nₛ,P} is the highest common factor of the number of slots and the number of the permanent magnets. Specifically, the displacement angle α_{sde} may be determined by electrical angle in the range of

$${90}^{°} \times \frac{H C F \{ {N}_{s} , P \}}{{N}_{s}} - \frac{{360}^{°}}{{N}_{s}}$$

$$to$$

$${90}^{°} \times \frac{H C F \{ {N}_{s} , P \}}{{N}_{s}} + \frac{{360}^{°}}{{N}_{s}} .$$

The angles stated herein mean electrical angles, which are different from typical mechanical angles, considering a spin cycle of any two contiguous N, S rotor poles turning past a stator tooth as 360° regardless of the number of poles of the rotor.

A plurality of N and S poled and skewed permanent magnets may be arranged on the upper and lower sections of the rotor to link magnetic flux of the permanent magnets to the upper and lower stators with the windings of the coil taken in a plurality of slots, and the plurality of skewed permanent magnets are fixedly mounted on the upper and lower sections of the rotor to generally constitute a closed circuit within magnetic field.

The plurality of N and S poled and skewed permanent magnets may be arranged on the upper and lower sections of the rotor to link magnetic flux of the permanent magnets to the upper and lower stators with the windings of the coil taken in the plurality of slots, and the plurality of skewed permanent magnets may be fixedly mounted on the upper and lower sections of the rotor to constitute independent closed circuit within magnetic field respectively on the upper and lower sections of the rotor.

The plurality of N and S poled and skewed permanent magnets may be made into a skewed shape “ [symbol] ” from an unskewed shape “ [symbol] ”.

The skewing angle of the permanent magnets may be expressed by electrical angle as

$$\frac{{360}^{°}}{L C M \{ {N}_{s} , P \}} \times \frac{P}{2}$$

and determined in the range of ±10°. Here, LCM{Nₛ,P} is the least common multiple of the number of slots and the number of the permanent magnets. Specifically, the skewing angle may be determined by electrical angle in the range of

$$\frac{{360}^{°}}{L C M \{ {N}_{s} , P \}} \times \frac{P}{2} - {10}^{°}$$

$$to$$

$$\frac{{360}^{°}}{L C M \{ {N}_{s} , P \}} \times \frac{P}{2} + {10}^{°} .$$

The upper stator and the lower stator may be equal in geometry with same number of the windings of the coil taken in the slots of the upper stator and the lower stator.

The upper housing and the lower housing may be respectively formed with housing ribs extending radially to reinforce the upper housing and the lower housing.

Another embodiment of the present disclosure provides an axial flux synchronous generator for a wind turbine generator, the synchronous generator including: a shaft coupled to receive power with a power generating apparatus for the wind turbine; a rotor coupled to the shaft and having upper and lower disk-like faces affixed with a plurality of skewed permanent magnets having north-south (N-S) poles and distantly arranged; an upper stator and a lower stator both having a plurality of slots formed similar in shape to the skewed permanent magnets and taking windings of a coil, the upper stator being twisted relative to the lower stator by an electric angle in the range of 0˜60° depending on the number of the slots; an upper housing and a lower housing for housing the rotor, the upper stator and the lower stator together; and a hub housing for fastening the upper housing and the lower housing to maintain constant gaps between the rotor and the upper stator and the lower stator.

According to a study conducted by the inventor, the cogging torque in the generator as above is the sum of the cogging torques by the upper stator and the lower stator, expressed by Equation 1.

τ_{c}=τᵤₚₚₑᵣ+τ_{lower} Equation 1

Here, τ_{c} is the total cogging torque of the generator, τᵤₚₚₑᵣ is the cogging torque of the upper stator and τ_{lower} is the cogging torque of the lower stator.

The inventor has formulated a generator cogging torque reduction method by installing the upper stator in a staggered arrangement with a predetermined displacement angle against the lower stator. Detailed description on the displacement angle for reducing the cogging torque is as follows.

The number of cogging torque occurrences per rotor revolution occurring at the respective upper and lower stators is N_{c} and may be expressed by Equation 2.

$${N}_{c} = \frac{P \times {N}_{s}}{H C F \{ {N}_{s} , P \}} \qquad Equation 2$$

Therefore, the mechanical angle at one cycle of cogging torque occurrence may be expressed by Equation 3.

$${α}_{c} = \frac{{360}^{°}}{{N}_{c}} \qquad Equation 3$$

α_{c} may be expressed by Equation 4 into electrical angle α_{ce}.

$${α}_{ce} = \frac{P}{2} {α}_{c} \qquad Equation 4$$

The above-mentioned electrical angle defines the unit 360° by a linking event from the N-S pole pair of the rotor to the stator regardless of the number of poles of the rotor.

As described with Equation 1, the cogging torque is expressed by the sum of the cogging torque from the upper stator and the cogging torque of the lower stator.

The stator displacement is for reducing the respective cogging torques from the upper and lower stators through repositioning the upper stator to move the phase of cogging torque occurrence at the upper stator by an amount as in Equation 5 to make the cogging torques at the upper and the lower stators cancel out to zero. Repositioning the upper stator to displace the phase of cogging torque occurrence by electrical angle of 180° can make the sum of the cogging torques at the upper and lower stators ‘0’.

$$\begin{matrix}{τ}_{c} = {τ}_{upper} sin ( θ + {180}^{°} ) + {τ}_{lower} sin θ \\ = - {τ}_{upper} sin θ + {τ}_{lower} sin θ = 0\end{matrix} \qquad Equation 5$$

Here, θ is a phase angle of the rotor in terms of the electrical angle. Accordingly, the stator repositioning displacement angle for the 180° movement of the phase of cogging torque occurrence at the upper stator may use Equation 4 and be expressed in electrical angle by Equation 6.

$$\begin{matrix}{α}_{sde} = \frac{1}{2} {α}_{ce} = \frac{1}{2} \times \frac{P}{2} \times {α}_{c} \\ = \frac{1}{2} \times \frac{P}{2} \times \frac{{360}^{°}}{{N}_{c}} \\ = \frac{1}{2} \times \frac{P}{2} \times \frac{{360}^{°} \times H C F \{ {N}_{S} , P \}}{P \times {N}_{s}} \\ = {90}^{°} \times \frac{H C F \{ {N}_{s} , P \}}{{N}_{s}}\end{matrix} \qquad Equation 6$$

Here, α_{sde} refers to a stator repositioning displacement angle expressed in electrical angle, α_{ce} an electrical angle of a cycle of cogging torque occurrence, α_{c} a mechanical angle of a cycle of cogging torque occurrence, and N_{c} is the number of cogging torque occurrences per rotor revolution.

The cogging toques of the upper and lower stators are phased from each other by 180° of electrical angle with a displacement angle of a half of α_{ce}. Accordingly, with the upper stator shifted by the displacement angle, the upper and lower stators turn out to generate phase inversed cogging torques to cancel each other out and thus reduce the overall cogging torque.

It should be understood that the above description of the electric generator embodiment in relation to the cogging torque is nonexclusively applicable to motors for electrically generating rotational power.

### Advantageous Effects

The axial flux permanent magnet synchronous generator for wind turbine generators of the present disclosure has the following advantageous effects.

Since the generator of the embodiment employs slotted upper and lower stators, it helps to improve the generation efficiency and higher output voltage over conventional axial flux permanent magnet synchronous generators which have been troubled with reduced generation efficiency and output voltage due to low generation voltage under relatively high magnetic resistance in airgap.

An upper stator twisted with respect to a lower stator by a predetermined electrical angle helps to reduce cogging torque to enable the accompanying wind turbine generator to start with small wind flow.

The configuration of a rotor fitted with permanent magnets and then adjoined by opposite stators on its top and bottom has the rotor serving as cooling fan to provide advantages in the aspects of generating efficiency and output voltage gain.

### DESCRIPTION OF DRAWINGS

FIG. 1 is a cross sectional view of a prior art axial flux permanent magnet coreless multi-generator;

FIG. 2 is a general perspective view of an axial flux permanent magnet synchronous generator using unskewed permanent magnets;

FIG. 3 is a view illustrating the shape and geometry of unskewed permanent magnets attached to a rotor of the synchronous generator of FIG. 2;

FIG. 4 is a general perspective view of an axial flux permanent magnet synchronous generator using skewed permanent magnets;

FIG. 5 is a view illustrating the shape and geometry of skewed permanent magnets attached to a rotor of the synchronous generator of FIG. 4;

FIG. 6 is a view for comparing the shapes and geometries of unskewed permanent magnets and the skewed permanent magnets;

FIG. 7 is a view illustrating the construction of an axial flux permanent magnet synchronous generator having an upper stator twisted with respect to a lower stator by an electrical angle of 25˜30°;

FIG. 8A is a view illustrating an axial flux permanent magnet synchronous generator establishing a closed circuit within a magnetic field generally by a rotor of the generator, the shapes and geometries of an upper and lower stators and upper and lower sections of the rotor;

FIG. 8B is a view illustrating an axial flux permanent magnet synchronous generator establishing an independent upper closed circuit and a lower closed circuit within a magnetic field by a rotor of the generator, the shapes and geometries of upper and lower stators and an upper and lower sections of the rotor;

FIG. 9 is a view illustrating an axial flux permanent magnet synchronous generator having an upper stator twisted with respect to a lower stator by the electrical angle;

FIG. 10 is a graph illustrating the cogging torque value of an axial flux permanent magnet synchronous generator of a preferred embodiment; and

FIG. 11 is a view illustrating the shapes and geometries of unskewed permanent magnets (ABCD) and skewed permanent magnets (A′, B′, C′, D′).

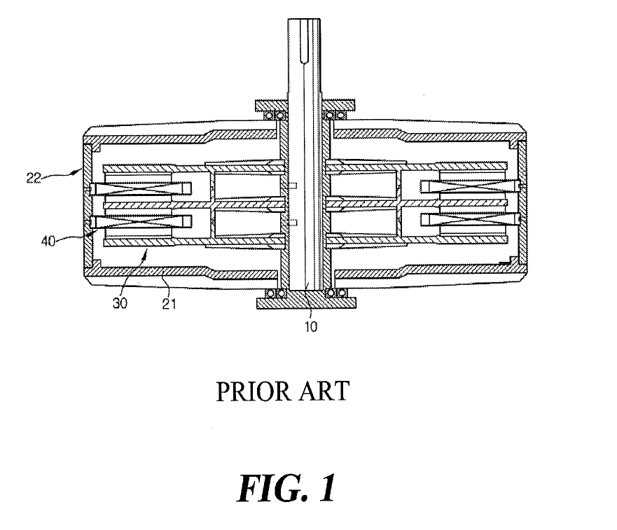

### DETAILED DESCRIPTION

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Detailed descriptions will be provided on an axial flux permanent magnet synchronous generator according to an embodiment, referring to the drawings.

This embodiment of the AFPM synchronous generator includes a shaft 100, a rotor 110, skewed permanent magnets 122, an upper stator 140a, a lower stator 140b, an upper housing 150a, a lower housing 150b and a hub housing 160.

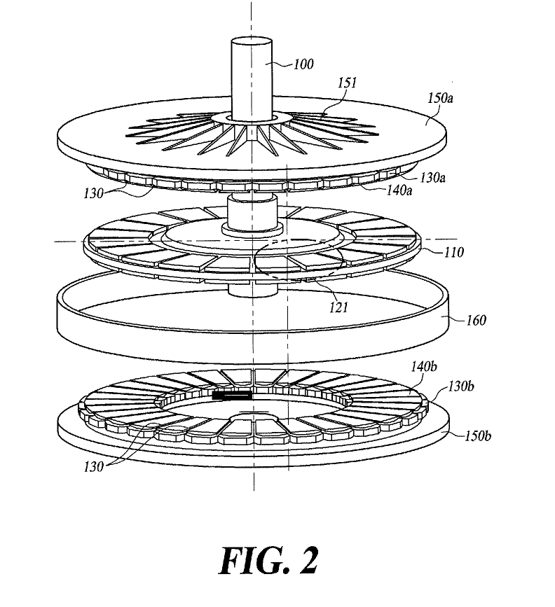

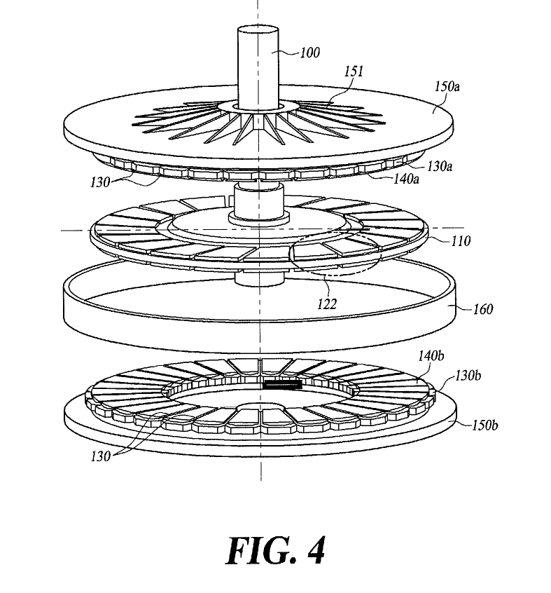

First, referring to FIGS. 2, 4 and 7, shaft 100 is a means for receiving a driving force from a driving force generation apparatus of a wind turbine generator. Shaft 100 is affixed to a rotating body (not shown) connected in turn to wind-powered blades (not shown) so that shaft 100 is rotationally driven by the rotating body to eventually rotate rotor 110.

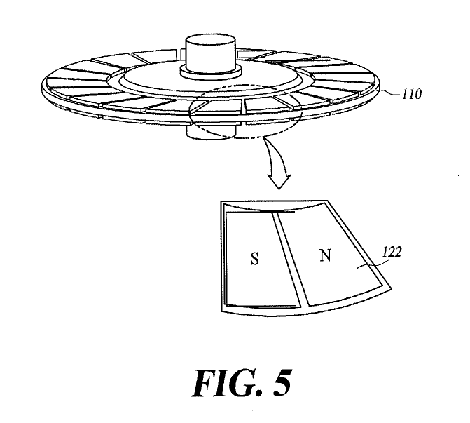

Referring to FIGS. 2 to 8, rotor 110 is a disk-like rotating means and has top and bottom disk faces affixed with a plurality of skewed permanent magnets 122 having north-south (N-S) pole pairs and distanced in a uniform array.

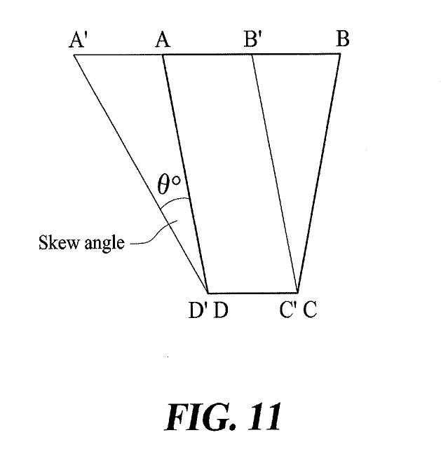

Here, the permanent magnet array fixture on the rotor serves to offset a cogging torque with counteracting skew. The permanent magnet skewing is a simple and effective way to reduce the cogging torque. Applying the magnet skewing is easier to AFPM machines than to radial flux permanent magnet (RFPM) machines since the AFPM machines have flat magnet surface and simpler magnet shape. FIG. 11 illustrates a PM skew shape applied in an embodiment. Skewing shapes include conventional skew, triangular skew, parallel-sided magnets, trapezoidal skew, circular magnets, dual-skew magnets. Among the PM skewing methods, the circular magnets are most effective against the cogging torque but its pole number for placement is limited due to the shape of circle and the present embodiment uses a simply manufactured and effective conventional skew in the design and interpretation of the AFPM synchronous generator.

FIG. 11 shows both the geometries of unskewed PM (ABCD) and skewed PM (A′, B′, C′, D′).

Minimum skew angle for minimizing cogging torque may be expressed as Equation 7.

$${θ}_{skew} = \frac{{360}^{°}}{L C M \{ {N}_{s} , P \}} \times \frac{P}{2} \qquad Equation 7$$

In Equation 7, θ_{skew} is skew angle (electrical angle).

In addition, if number of slots/number of magnets=integer, Equation 8 may be provided.

$${θ}_{skew} = \frac{{360}^{°}}{{N}_{s}} \times \frac{P}{2} \qquad Equation 8$$

However, leakage magnetic flux of internal and external pole arcs of PM generally exhibits a slightly larger value than the minimum cogging torque skew angle unlike Equation 7.

As shown in the drawings, in this embodiment, the number of permanent magnets is twenty and the number of slots is thirty. The skew angle is 50˜70° in electrical angle according to the present embodiment, although it may change depending on the size or shape and number of the magnets.

As for the positions of the permanent magnets and windings, the magnets may be located externally of stator windings, and vice versa. The external placement of the magnets have high effectiveness due to shorter airgap for the magnet flux to cross with some deficiency in thermal characteristics on cooling because of the highly febrile armature windings placed inside of the generator, whereas the present embodiment provides rotor 110 internally disposed and having the skewed and mounted PM array and the stator windings (or the upper and lower stators) disposed externally as illustrated, which turns rotor 110 to serve as a fan for an excellent cooling effect on the armature windings in operation of the generator and provides advantages in the aspects of generating efficiency and output voltage gain.

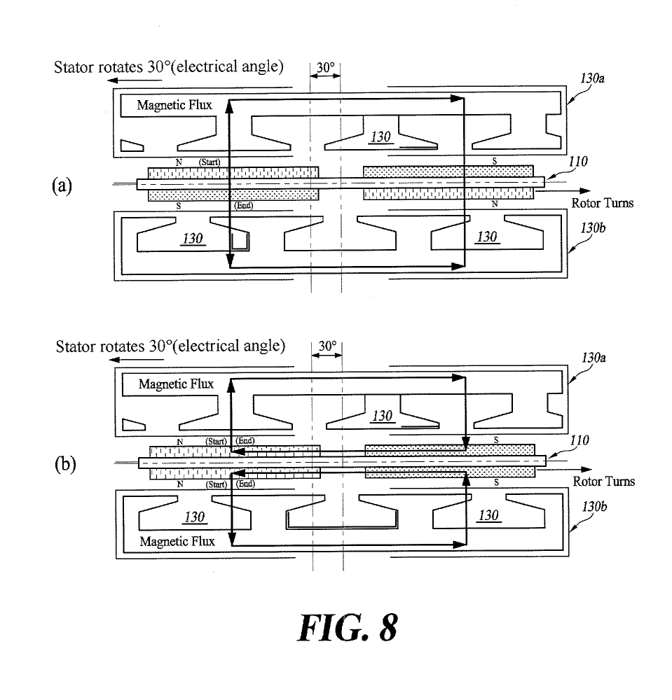

Meanwhile, referring to an embodiment of FIG. 8A, multiple skewed magnets 122 have N-S pole permanent magnets fixedly mounted on the opposite surfaces of rotor 110, and upper and lower stators 140a, 140b each has a plurality of slots for accommodating coil windings so that magnetic flux is linked with upper and lower stators 140a, 140b as the opposite rotor surfaces as a whole constitute a closed circuit within magnetic field.

To be more specific, the N-S pole magnets are mounted fixedly on the opposite surfaces of rotor 110 so that the N and S poles on the upper surface are opposingly staggered with respect to the N and S poles on the lower surface so that the opposite rotor surfaces as a whole constitute the closed circuit within magnetic field.

In this event, linkage of the magnetic flux with upper and lower stators 140a, 140b is established so that upper stator 140a is linked with magnet flux from the N poles to S poles of the skewed magnet array fixed onto the upper surface of rotor 110 as the magnet flux exiting the upper S poles continues to flow from the N poles to S poles of the skewed magnet array fixedly mounted on the lower surface of rotor 110 to eventually link with lower stator 140b.

In addition, referring to an embodiment of FIG. 8B, multiple skewed magnets 122 have N-S pole permanent magnets mounted fixedly on the opposite surfaces of rotor 110, and upper and lower stators 140a, 140b each has a plurality of slots for accommodating coil windings so that magnetic flux is linked with upper and lower stators 140a, 140b as the opposite rotor surfaces respectively constitute independent closed circuits within magnetic field.

In other words, N-S pole magnets 122 are arrayed on the upper and lower surfaces of rotor 110 so that the upper N and S poles oppose the lower N and S poles through rotor 110 for the upper and lower surfaces of rotor 110 to respectively constitute the independent closed circuits within magnetic field.

Here, linkage of the magnetic flux with upper and lower stators 140a, 140b is established so that upper stator 140a is linked with magnet flux flowing from the N poles to S poles of the skewed magnet array fixed onto the upper surface of rotor 110 and independently defining a closed circuit within magnetic field as lower stator 140b is linked with another magnet flux flowing from the N poles to S poles of the skewed magnet array fixed onto the lower surface of rotor 110 and independently defining another closed circuit within magnetic field.

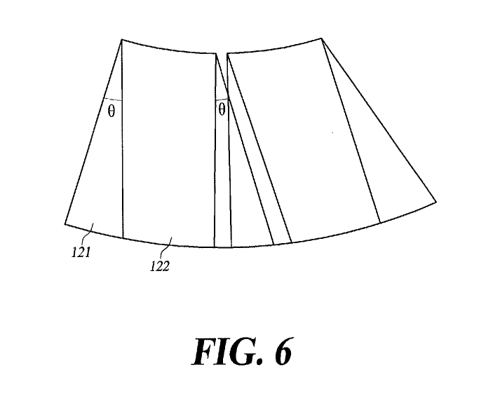

Referring to an embodiment of FIG. 6, multiple skewed magnets 122 are made into a modified skewed shape “ [symbol] ” with the magnet skew applied by an electrical angle in the range of 50˜70° as compared with an unskewed shape “ [symbol] ” in order to decrease cogging torque.

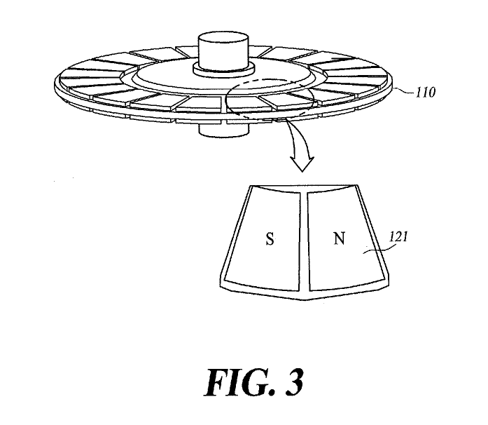

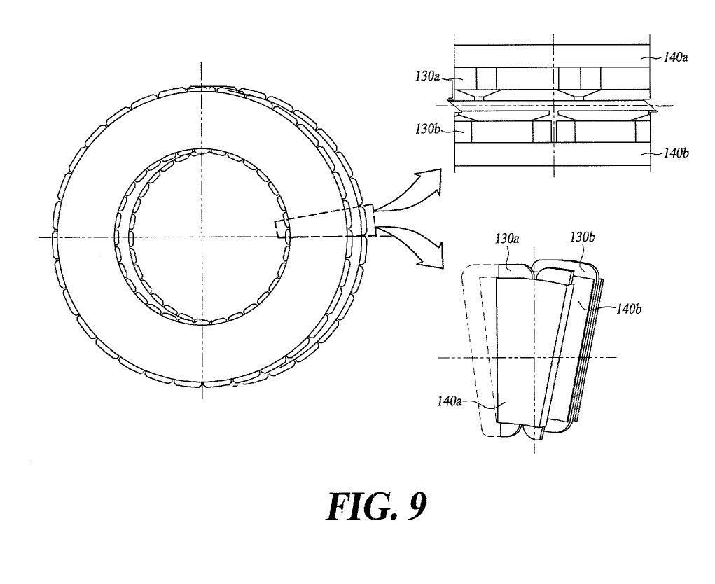

Referring to FIGS. 3, 5, 8 and 9, upper and lower stators 140a, 140b are means for connecting coils 130a, 130b and serving as conduits of magnetic flux generated by magnets 122. Coils 130a, 130b are evenly wound around a plurality of slots 130 shaped and geometrically designed similar to skewed magnets 122, and upper stator 140a is in an angled posture relative to lower stator 140b by an electrical angle of 25˜30° in order to reduce the cogging torque and boost the generator output. Upper and lower stators 140a, 140b are positioned above and below rotor 110 and held in place by upper housing 150a and lower housing 150b.

Cogging torque refers to the irregular occurrences of torque in generator or motors and it is a tangential force with a tendency to move toward a lowest magnetic energy point in a generator system and irrelevant to a load current but generated by interactions between the rotor permanent magnets and the stator slots.

According to an embodiment, upper and lower stators 140a, 140b are identically made in geometry with slots 130 of upper and lower stators 140a, 140b taking a same number of windings in order to generate even quantity of cogging torque and output.

Upper and lower stators 140a, 140b according to an embodiment are in a twisted arrangement where upper stator 140a is angled relative to lower stator 140b by an electrical angle of 0˜60° depending on the number of slots 130 in order to reduce the cogging torque.

In an embodiment, the axial flux permanent magnet synchronous generator features upper stator 140a being twisted relative to lower stator 140b inversely of the rotational direction of rotor 110 by an electrical angle of 25˜30° as a technical construction for reducing the cogging torque. Twisting upper stator 140a by an electrical angle of 25˜30° causes the cogging torque from upper stator 140a to be generated inversely of the cogging torque from lower stator 140b so that the inverse cogging torques interactively neutralize each other within the generator to minimize cogging torque at the start of the generator.

The major challenge of the present embodiment is the high cogging torque problem that a large cogging torque combined with the intrinsic high magnetic flux density of the rare earth magnet for constituting the rotor permanent magnets required too high starting torque to disable wind turbine generators to start with a small wind, which reduces the generator efficiency and output performance. The present embodiment now resolves the problem by minimizing the cogging torque with the electrical angular twists in the range of 25˜30° between upper and lower stators 140a, 140b to boost the generator efficiency and output performance leading to a smooth starting operation of the wind turbine generator under a small wind flow.

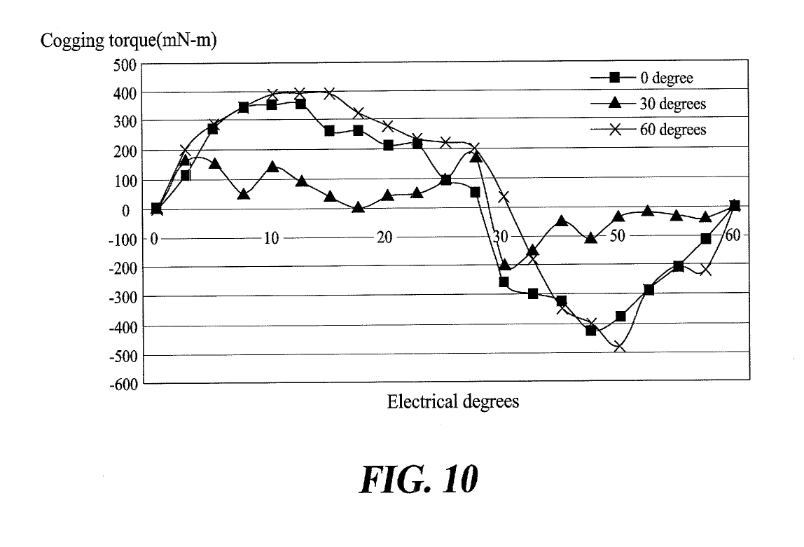

FIG. 10 is a graph illustrating the cogging torque changes as upper stator 140a is twisted relative to lower stator 140b in reverse to the rotational direction of rotor 110.

According to the present embodiment, the cogging torque gradually decreases as the twisting angle of upper stator 140a reaches the lowest value at 30° (electrical angle), and bounces gradually to show the similar outcome at 60° to the outcome at 0° of electrical angle.

The twisting angle of upper stator 140a may be variable depending on the shapes, sizes and number of slots. Table 1 below shows different cogging torques by slot displacements in degrees.

TABLE 1

Cogging torque(mN-m)

| Slot displacement | Per Unit System | Real Value |
|---|---|---|
| 0 degree | 1 | 429 |
| 30 degrees | 0.48 | 210 |
| 60 degrees | 1.01 | 435 |

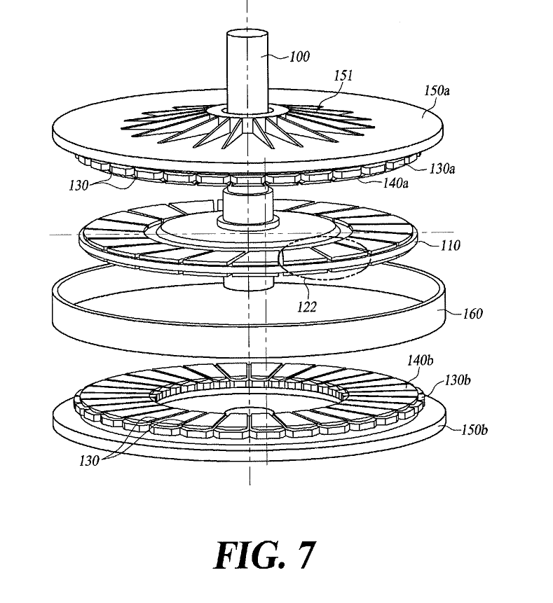

Referring to FIG. 7, as a means for joining rotor 110 and upper and lower stators 140a, 140b together, upper housing 150a and lower housing 150b are designed to be fastened to the top and bottom of hub housing 160 as they lock upper stator 140a in its twisted position in the inversed rotational direction of the rotor relative to lower stator 140b in order to minimize chances of cogging torque occurring due to movements or vibrations of the generator while allowing an easy discharge of heat produced from the stator windings in the process of power generation.

On the outer surfaces of upper housing 150a and lower housing 150b, a number of housing ribs 151 are installed for reinforcing the mechanical strength of upper and lower housings 150a, 150b.

Hub housing 160 serves as a means for affixing upper and lower housings 150a, 150b to suspend upper and lower stators 140a, 140b respectively with a constant gap approximating 1 mm against rotor 110 to facilitate generating magnetic flux by the permanent magnets within the generator. Additionally, hub housing 160 is fastened to upper and lower stators 140a, 140b in such a way to prevent the movements or vibrations of the generator from deforming the internal structure of the generator and to facilitate discharges of heat generated inside of the generator in operation.

Referring to FIGS. 2 to 10, description will be provided on an axial flux permanent magnet synchronous generator for wind turbine generators according to an embodiment will be described.

An embodiment of the present disclosure includes shaft 100, rotor 110, upper stator 140a, lower stator 140b, upper housing 150a, lower housing 150b, and hub housing 160, wherein shaft 100 is coupled to a driving force generating apparatus for transmitting a driving force to the synchronous generator; rotor 110 is coupled rotatably to shaft 100 and has opposite disk-like faces affixed with a plurality of skewed permanent magnets having N-S pole pairs and equidistantly arranged; upper stator 140a and lower stator 140b both have uniform windings of coil 131 under the influence of magnetic flux of skewed permanent magnets 122 fixed to rotor 110 with upper stator 140a twisted in reversed rotational direction of rotor 110 relative to lower stator 140b by an electrical angle in the range of 25˜30° in order to decrease cogging torque and boost the generator output; upper housing 150a and lower housing 150b for fastening rotor 110 and upper and lower stators 140a, 140b together in order to prevent the stators from being dislocated due to movements or vibrations of the generator; and hub housing 160 keeps upper and lower housings 150a, 150b in place to have constant gaps maintained between rotor 110 and suspended upper and lower stators 140a, 140b that are fastened to upper and lower housings 150a, 150b. This construction of the axial flux permanent magnet synchronous generator is advantageous that an electrical angle of 25˜30° of twisted orientation of the upper stator relative to lower stator causes the cogging torque from upper stator 140a to counteract the cogging torque from lower stator 140b resulting in neutralization of the opposing generations of cogging torques within the generator, minimizing occurrences of the cogging torque problem at the start of the generator.

An additional feature of the axial flux permanent magnet synchronous generator according to an embodiment is to differentiate the positions of upper and lower stators 140a, 140b to overcome the cogging torque problem involved in the conventional axial flux permanent magnet synchronous generators, and thereby provide starting generators at small wind flow with increased generator output and efficiency.

Although exemplary embodiments of the present disclosure have been described for illustrative purposes, those skilled in the art will appreciate that various modifications, additions and substitutions are possible, without departing from essential characteristics of the disclosure. Therefore, exemplary embodiments of the present disclosure have not been described for limiting purposes. Accordingly, the scope of the disclosure is not to be limited by the above aspects but by the claims and the equivalents thereof.

[Reference Numerals]

| 100: Shaft | 110: Rotor |
|---|---|
| 121: Unskewed Permanent Magnet | |
| 122: Skewed Elements | |
| 130a: Upper Coil | 130b: Lower Coil |
| 140a: Upper Stator | 140b: Lower Stator |
| 150a: Upper Housing | 150b: Lower Housing |
| 151: Housing Rib | 160: Hub Housing |

### CROSS-REFERENCE TO RELATED APPLICATION

If applicable, this application claims priority under 35 U.S.C §119(a) of Patent Application No. 10-2011-0085567, filed on Aug. 26, 2011 in Korea, the entire content of which is incorporated herein by reference. In addition, this non-provisional application claims priority in countries, other than the U.S., with the same reason based on the Korean Patent Application, the entire content of which is hereby incorporated by reference.

1. An electricity or driving force generator comprising:
a shaft;
a rotor coupled rotatably to the shaft and having upper and lower disk-like faces affixed with a plurality of skewed permanent magnets having north-south (N-S) poles and distantly arranged;
an upper stator and a lower stator both having a plurality of slots formed similar to the skewed permanent magnets and taking windings of a coil, the upper stator being displaced relative to the lower stator by an electric angle in the range of 25-30°;
an upper housing and a lower housing for housing the rotor, the upper stator and the lower stator together; and
a hub housing for fastening the upper housing and the lower housing to maintain constant gaps between the rotor and the upper stator and the lower stator.

2. The electricity or driving force generator of claim 1, wherein the plurality of skewed permanent magnets are arrayed on the upper and lower sections of the rotor to link magnetic flux of the skewed permanent magnets to the upper and lower stators with the windings of the coil taken in the plurality of slots, and the plurality of skewed permanent magnets are installed so that the upper and lower sections of the rotor as a whole establish a closed circuit within magnetic field.

3. The electricity or driving force generator of claim 1, wherein the plurality of skewed permanent magnets are arrayed on the upper and lower sections of the rotor to link magnetic flux of the skewed permanent magnets to the upper and lower stators with the windings of the coil taken in the plurality of slots, and the plurality of skewed permanent magnets are installed so that the upper and lower sections of the rotor respectively establish an independent closed circuit within magnetic field.

4. The electricity or driving force generator of claim 2, wherein the plurality of skewed permanent magnets are provided with skewing by an electrical angle in the range of 50-70°.

5. The electricity or driving force generator of claim 1, wherein the upper stator and the lower stator are made equally in geometry with same number of the windings of the coil taken in the slots of the upper stator and the lower stator.

6. The electricity or driving force generator of claim 1, wherein the upper housing and the lower housing are respectively formed with housing ribs extending radially to reinforce the upper housing and the lower housing.

7. An electricity or driving force generator comprising:
a shaft;
a rotor coupled rotatably to the shaft and having upper and lower disk-like faces affixed with a plurality of skewed permanent magnets having north-south (N-S) poles and distantly arranged;
an upper stator and a lower stator both having a plurality of slots formed similar to the skewed permanent magnets and taking windings of a coil, the upper stator being twisted relative to the lower stator by an electric angle in the range of 0-60° depending on the number of the slots;
an upper housing and a lower housing for housing the rotor, the upper stator and the lower stator together; and
a hub housing for fastening the upper housing and the lower housing to maintain constant gaps between the rotor and the upper stator and the lower stator.

8. An electricity or driving force generator comprising:
a shaft;
a rotor coupled to corotate with the shaft and including a plurality of magnets skewed and arranged circumferentially;
a first stator placed at one side of the rotor and having a circumferential arrangement of a plurality of slots with windings of a coil; and
a second stator placed at the other side of the rotor in a staggered opposing relation to the first stator with a predetermined displacement angle.

9. The electricity or driving force generator of claim 8, wherein the predetermined displacement angle is determined by electrical angle in the range of
$${90}^{°} \times \frac{H C F \{ {N}_{s} , P \}}{{N}_{s}} - \frac{{360}^{°}}{{N}_{s}} to {90}^{°} \times \frac{H C F \{ {N}_{s} , P \}}{{N}_{s}} + \frac{{360}^{°}}{{N}_{s}} .$$

10. The electricity or driving force generator of claim 8, wherein the plurality of magnets have a skewing angle determined by electrical angle in the range of
$$\frac{{360}^{°}}{L C M \{ {N}_{s} , P \}} \times \frac{P}{2} - {10}^{°} to \frac{{360}^{°}}{L C M \{ {N}_{s} , P \}} \times \frac{P}{2} + {10}^{°} .$$

11. The electricity or driving force generator of claim 8, wherein the displacement angle is determined as a function of the number of the magnets of the rotor and the number of the slots.

12. The electricity or driving force generator of claim 3, wherein the plurality of skewed permanent magnets are provided with skewing by an electrical angle in the range of 50-70°.
